(19) United States
(12) Patent Application Publication
(10) Pub. No.: US 2021/0350160 A1
(43) Pub. Date: Nov. 11, 2021

(54) System And Method For An Activity Based Intelligence Contextualizer

(71) Applicant: Booz Allen Hamilton Inc., Mclean, VA (US)

(72) Inventors: Chase Allen CHAPMAN, St. Charles, MO (US); William A JONES, Richmond Heights, MO (US)

(73) Assignee: Booz Allen Hamilton Inc., McLean, VA (US)

(21) Appl. No.: 16/868,704

(22) Filed: May 7, 2020

(51) Int. Cl. G06K 9/32; G06T 11/20; G06K 9/00

(52) U.S. Cl. CPC G06K 9/3233; G06T 2210/12; G06K 9/00771; G06T 11/20

(57) ABSTRACT

The systems and methods of the present disclosure are directed to monitoring activity in an area of interest by contextualizing activity-based intelligence data received from one or more disparate data sources. The computing system selects one or more watchboxes for analyzing the features of the received data and uses one or more bounding boxes to analyze the features of the received data according to data type. The analysis includes comparing the features of the one or more bounding boxes against one or more reference data values of feature indicators associated with an activity defined by an activity model associated with the selected watchbox. The reference data of feature indicators is used to identify and track changes in spatial, temporal, aural, spectral, and other types of characteristic data to identify variations in an activity and the significance of the variations in the activity to the area of interest being monitored.

### FIELD

The present disclosure relates to systems and methods for monitoring an area of interest.

### BACKGROUND

Threat assessment can involve data collection from multiple sources to determine abnormal activities from normal patterns of activities, and/or other relationships of activities to specified reference patterns of activities. Human analysts have an important role in identifying potential threats. For example, an analyst can gather actionable information from a system, process, or intelligence sources, and create one or more relevant reports by applying their acquired domain knowledge to the information. In fields which use overhead imagery, an analyst may spend seconds or minutes on any individual piece of intelligence, and combine multiple sources of information so that a true representation and comprehensive report on the observed activities in an area of interest can be generated.

Given the volume of data, the near instantaneous rate at which current intelligence sources can deliver information, the plethora of intelligence information collected in the past which has yet to be analyzed, when considering numbers alone, the current analyst workforce is incapable of fully assessing and exploiting the collected information. The analytical burden presented by the volume, different sources, and different types of information can be relieved through strategic use of machine learning algorithms to process the intelligence information. However, the mere processing of intelligence information only minimally reduces the analytical burden. A solution for lessening the analytical burden can involve the contextualization and prioritization of the collected information.

### SUMMARY

An exemplary computer system for monitoring an area of interest for activity is disclosed. The computer system, comprising: a receiving device configured to receive data including one or more features of an area of interest; a memory device configured to store (i) reference data comprised of a baseline of data values corresponding to feature indicators, where said feature indicators define one or more metrics for activities monitored via one or more watchboxes associated with the area of interest, and the baseline of data values corresponds to one or more reference values associated with the feature indicators, and (ii) activity data corresponding to one or more of the feature indicators of the one or more watchboxes; a computing device configured to: compare one or more features of the received data to the reference data of the at least one feature indicator defining the one or more watchboxes; select at least one watchbox of the one or more watchboxes if the comparison identifies a correspondence between the one or more features of the received data and the reference data of the at least one selected watchbox; analyze the one or more features of the received data against the one or more reference data of the feature indicators associated with the at least one selected watchbox to determine whether the one or more features trigger a reportable activity based on an indicator threshold associated with the one or more feature indicators or one or more combinations of the one or more feature indicators; and generate a data signal encoded with information associated with at least one of: the at least one selected watchbox, the one or more features of the received data analyzed in the at least one selected watchbox, and an analysis result indicating whether the one or more features of the received data trigger a reportable activity; and an output device configured to output the data signal.

An exemplary method is disclosed for monitoring an area of interest for activity via a computer system having a computing device configured to execute one or more activity models. The method comprising: receiving, in a receiving device of the computer system, data including one or more features of an area of interest; storing, in a memory device, (i) reference data comprised of a baseline of data values corresponding to feature indicators, where said feature indicators define one or more metrics for activities monitored via one or more watchboxes associated with the area of interest, and the baseline of data values corresponds to one or more reference values associated with the feature indicators, and (ii) activity data corresponding to one or more of the feature indicators of the one or more watchboxes; selecting, via a processing device of the computing device, at least one watchbox of the one or more watchboxes if the comparison identifies a correspondence between the one or more features of the received data and the reference data of the at least one selected watchbox; analyzing, in a processing device of the computer system, the one or more features of the received data against the one or more reference data of the feature indicators associated with the at least one selected watchbox to determine whether the one or more features trigger a reportable activity based on an indicator threshold associated with the one or more feature indicators or one or more combinations of the one or more feature indicators; generating, in the processing device of the computing device, a data signal encoded with information associated with at least one of: the at least one selected watchbox, the one or more features of the received data analyzed in the at least one selected watchbox, and an analysis result indicating whether the one or more features of the received data trigger a reportable activity; and outputting the data signal via an output interface or transmitter of the computing device.

### BRIEF DESCRIPTION OF THE DRAWINGS

Exemplary embodiments are best understood from the following detailed description when read in conjunction with the accompanying drawings. Included in the drawings are the following figures:

FIG. 1 illustrates a system for monitoring an area of interest in accordance with an exemplary embodiment of the present disclosure.

FIG. 2 illustrates a map displaying watchboxes in accordance with an exemplary embodiment of the present disclosure.

FIG. 3A illustrates software modules of the computing device in accordance with an exemplary embodiment of the present disclosure.

FIGS. 3B-3D illustrate bounding boxes of the received data in accordance with an exemplary embodiment of the present disclosure.

FIGS. 4A and 4B illustrate a method for monitoring an area of interest in accordance with an exemplary embodiment of the present disclosure.

FIG. 5 illustrates an analysis process performed by the computing device in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

Exemplary embodiments of the present disclosure are directed to a system and method for use with activity-based intelligence (ABI) systems. ABI is an analytical construct that synthesizes data obtained from multiple data sources to identify patterns and changes in human behavior and/or activity. However, it should be noted that these embodiments can be used to monitor naturally occurring activity such as volcanic activity, ocean currents, storm patterns, animal migration patterns, etc. The acquired intelligence is used by analysts to classify the pattern and/or activity and drive decision making relative to whether the activity is normal, abnormal, and/or significant and whether a response to the activity is necessary. The exemplary systems and methods of the present disclosure are designed for interfacing with an ABI system and processing the collected data via one or more algorithmic models so that specified activities and/or behaviors can be identified and monitored. The algorithmic models are configured to convert intelligence data into identifiable information and, using logic and previous analyst experience, elevate that information to knowledge prior to the analyst viewing the collected information. The systems and methods of the present disclosure are directed to receiving intelligence data concerning an area of interest from one or more intelligence sources. The intelligence data can encompass numerous pieces of disparate information. The features of the disparate information are processed according to predetermined feature indicators of one or more selected watchboxes. The one or more watchboxes being selected based on an activity model. Each watchbox compares features of the received data against one or more predetermined feature indicators associated with an activity. The predetermined indicators allowing the identification and tracking of spatial, temporal, and spectral changes in the data to identify changes in the activity and the significance of the changes to the activity or event being monitored.

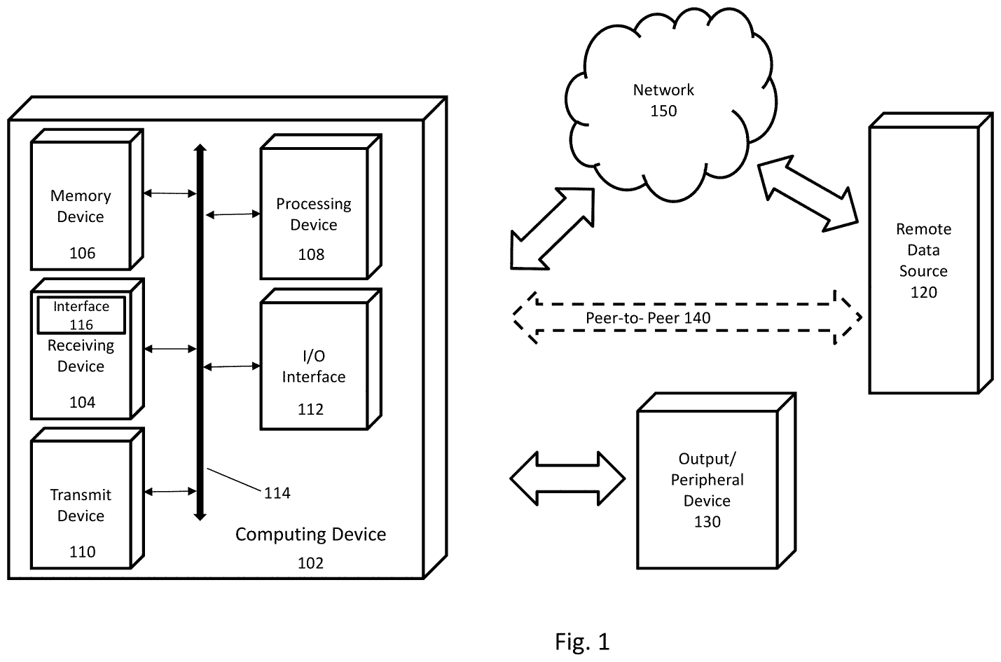

FIG. 1 illustrates a system for monitoring an area of interest in accordance with an exemplary embodiment of the present disclosure.

As shown in FIG. 1, the system 100 can include a computing device 102 configured with a combination of hardware and software components according to exemplary embodiments disclosed herein. The system 100 can include a receiving device 104, a memory device 106, a processing device 108, a transmitting device 110, and an input/output (I/O) interface 112. The receiving device 104 is configured to receive data from one or more local or remote data sources 120, which can include any one or more of: an image sensor, acoustic sensor, temperature sensor, vibration sensor, accelerometer, pressure sensor, mobile processing device, a database, computer network (e.g., server), a remote processing device, cellular or broadband network, or any other suitable device arranged, configured, or positioned to obtain, detect, generate, or store data of interest. It should be understood by one of skill in the art that any of the one or more sensors can include a smart sensor configured to convert a measurement into a digital data stream. According to an exemplary embodiment, the received data can include image data (e.g., still or video images), acoustic data, text or any other suitable data type associated with the data source. The computer network can provide access to data originating from Really Simple Syndication (RSS) feeds, blogs, social media sites, Internet sites, and/or any other suitable data or information source as desired. Moreover, the data obtained from the one or more local or remote data sources 120 can be collected in real-time or from a memory or storage device.

The receiving device 104 can be connected to the remote data source 120 via a peer-to-peer connection 140 or through a network 150. The peer-to-peer connection 140 can be configured for wireless communication without an intermediate device or access point. The network 150 can be configured for wired or wireless communication, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. According to an exemplary embodiment in which the data source 120 is local to the computing system 100, the receiving device 104 can be connected to the data source 120 via a local bus or communications interface discussed later in further detail.

The receiving device 104 can include a hardware component such as an antenna, a network interface (e.g., an Ethernet card), a communications port, a PCMCIA slot and card, or any other suitable component or device as desired for communicating with the one or more remote data sources 120 and/or the network 150. The receiving device 104 can store or be configured to access software or program code for receiving digital data according to one or more communication protocols and data formats. The receiving device 104 can be configured to process and/or format the received data signals and/or data packets which include intelligence data from one or more of the remote sources 120. For example, the receiving device 102 can be configured to identify components of the received data via a header and parse the data signal and/or data packet into small frames (e.g., bits, bytes, words) or segments for further processing by the processing device 108 via the communication interface 114. According to an exemplary embodiment of the present disclosure, the receiving device 104 can be configured to determine whether the digital data includes image data, audio data, text, or other types of data. Further, image data can be processed according to whether the images are still images (small images) or video images. The received video image and/or acoustic signal can be parsed into a plurality of frames, which can be analyzed individually to extract the corresponding information.

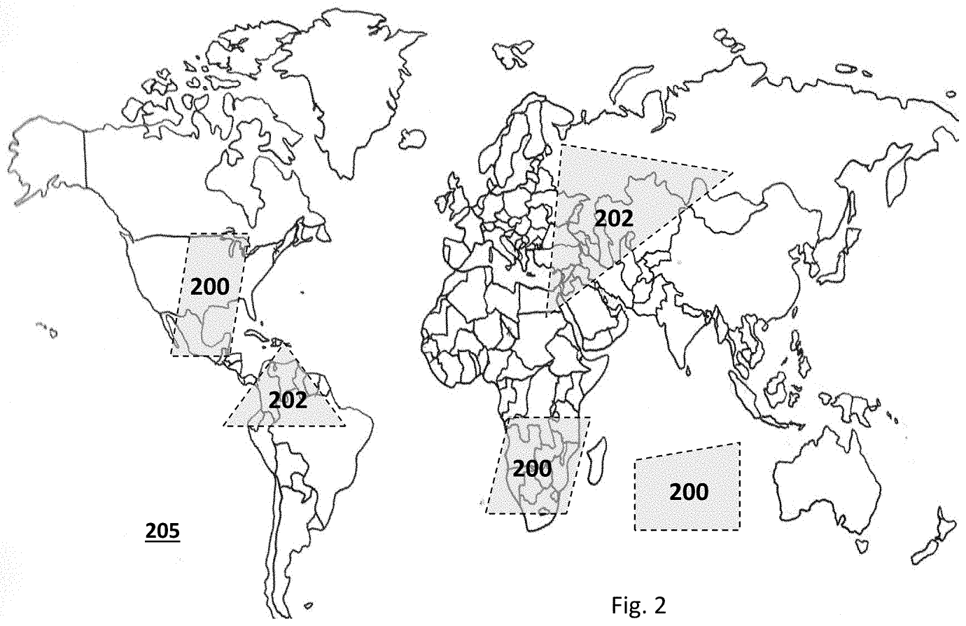

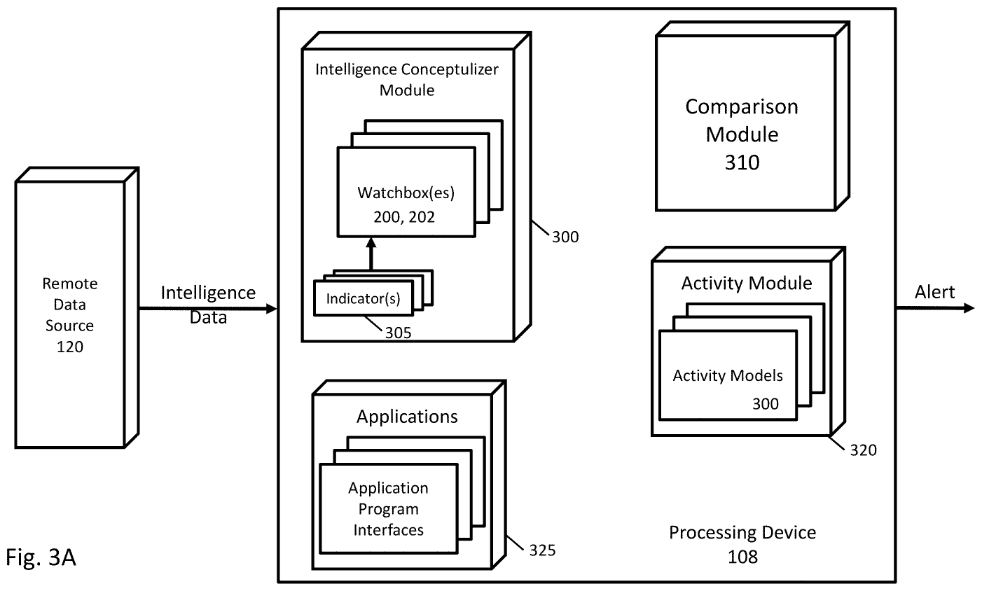

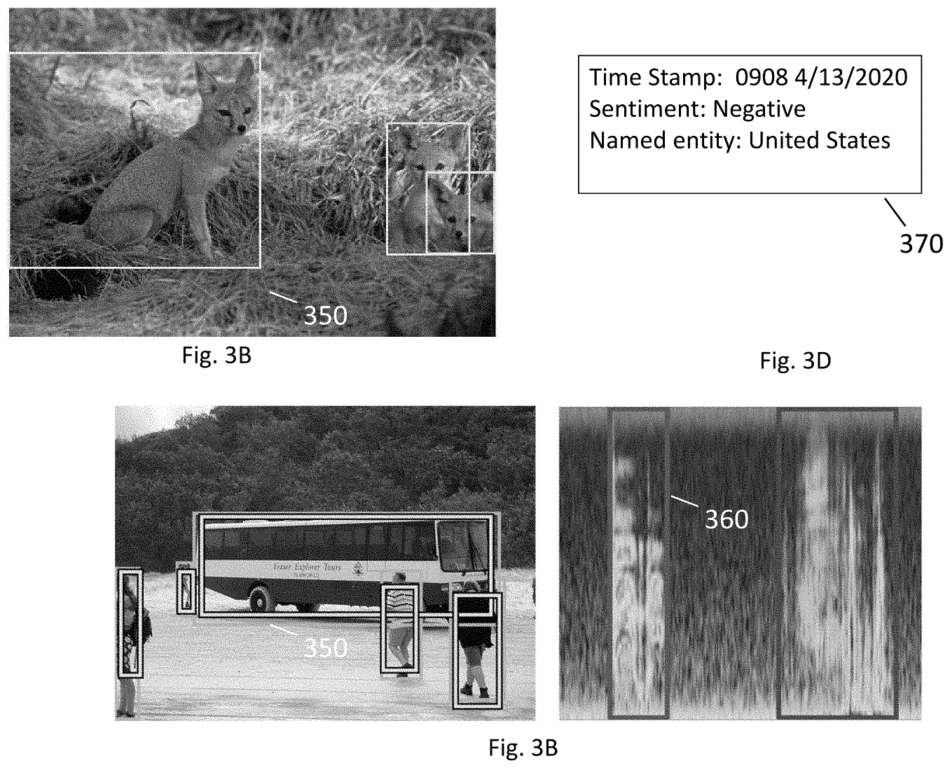

The computing system 100 also includes a memory device 106 configured to store (i) reference data comprised of a baseline of data values corresponding to feature indicators, where said feature indicators define one or more metrics for activities monitored via one or more watchboxes associated with an area of interest, and the baseline of data values corresponds to one or more reference values (e.g., values representative of normal activity) associated with the feature indicators, and (ii) activity data corresponding to one or more of the feature indicators of the one or more watchboxes. FIG. 2 illustrates a map displaying watchboxes 200 in accordance with an exemplary embodiment of the present disclosure. FIG. 3A illustrates software modules which can be executed by the processing device of the computing device in accordance with an exemplary embodiment of the present disclosure. The processing device 108 can be configured to access the software modules from the memory device 106 or the network 150. The software modules can include, for example, a conceptualizer module 300, a comparison module 310, an activity module 320, and application program interfaces 325. The conceptualizer module 300 is configured to activate one or more watchboxes 200, 202, which have associated and predefined feature indicators 305 for measuring activity within the related watchbox. The comparison module 310 is configured to use one or more bounding boxes or feature indicators associated with the received data for comparing features of the received data with the one or more feature indicators 305 associated with each watchbox 200, 202. The activity module 320 is configured to execute an activity model 300 which is associated with a specified watchbox 200, 202. The application program interfaces 325 can include a plurality of software applications associated with one or more activity models 300 which define an activity to be monitored in an area of interest. The activity models 300 can include reference data associated with features used to designate a specified activity or event in the data under analysis. Each activity model 300 can be associated with one or more watchboxes. The processing device 108 can use one or more bounding boxes for executing a suitable algorithm to compare features in the received data to reference features of the watchboxes 200, 202 based on data type.

As shown in FIG. 2, the positioning of each watchbox on a map can be defined according to geospatial or Global Positioning System (GPS) coordinates and/or a specified time range (e.g., year(s), day(s), month(s), hour(s), minute(s), or any other temporal unit of reference as desired). The granularity at which a watchbox is defined can be determined by the processing speed and/or processing power of the system on which the exemplary embodiments are executed. The activity model 300 can be selected to correspond to a specified activity to be monitored, such as one or more of building construction, meeting or gathering of people (e.g., march, riot, protest, demonstration, concert, sporting event, social event, religious event, etc.), amassing of troops, amassing of vehicles (e.g., cars, trucks, motorcycles, aircraft, watercraft, etc.), or any other activity as desired. The one or more feature indicators define various spatial, temporal, and/or spectral parameters and/or properties of a watchbox, and can define, for example, a time frame, a topic or theme prompting analysis of the area of interest, properties of the area of interest to be monitored, objects to be monitored within the area of interest, keywords or phrases to be monitored in data from reports, documents, articles, publications, social media sources, individuals to be monitored in the area of interest, and any other features and/or parameters associated with the area of interest as desired.

The watchboxes 200 can be positioned or overlayed on a map 205 according to geospatial coordinates and/or a time range for monitoring an area and/or topic of interest. The one or more watchboxes 200 can be defined according to a user-selected geometry having a size (e.g., area, footprint) suitable for capturing features and/or properties of events and/or activity occurring in the designated area to be monitored. The one or more watchboxes configured to monitor a topic of interest can be applied to or overlaid on a map without also having specified geospatial coordinates or a designated location on the map for monitoring. In this manner, the one or more watchboxes are configured to monitor the entirety of an area covered by the map. The map 205 can be set to any suitable or desired level of detail. For example, the map can be a large-scale map showing details (e.g., buildings, homes, trees, vehicles, sidewalks, roads, etc.) of a localized area or small-scale map showing an area larger than the large-scale map and with fewer topographic details. According to another exemplary embodiment, the topics of interest can be monitored through information (e.g., text, phrases, symbols, characters, etc.) obtained from documents, conversations, communications, blog postings, email, instant messaging services, news feeds, video feeds, podcasts, or any other media through which information can be communicated between people or entities.

The processing device 108 can be configured to compare one or more reference attributes of the received data to stored data defining the one or more watchboxes 200, select at least one watchbox 202 of the one or more watchboxes 200 if the comparison identifies a correspondence between the one or more reference attributes of the received data and the reference data of the at least one selected watchbox 202, and analyze at least one feature from the received data according to the one or more indicators associated with the at least one selected watchbox 202. As shown in FIG. 3A, the processing device 108 can be configured to compare attributes of the reference data and received data by executing one or more activity models 300. As the data is received, the processing device 108 can generate a prompt via an application program interface 325 which allows the user to select one or more activity models 300 for attribute comparison. According to an exemplary embodiment, the processing device 108 can be configured to automatically select one or more of the activity models 300 for attribute comparison. The degree of correspondence between reference attributes and the attributes of the received data determines which one or more of the plural watchboxes 200 are selected. For example, the processing device 108 can be configured to select a watchbox 202 based on a percent correspondence of attributes greater than 75%. It should be understood that the selection of the watchbox 202 can be determined based on any percent correspondence of attributes according to a desired sensitivity for detecting activity.

FIGS. 3B-3D illustrate bounding boxes or attribute files of the received data in accordance with an exemplary embodiment of the present disclosure. The processing device 108, via the activity model 300 which corresponds to the selected one or more watchboxes 202, can be configured to compare the features of the received data to the reference data or feature indicators 305 of the selected watchbox 202. The features of the received data are identified through one or more bounding boxes 350 and 360 or attribute files 370. The bounding boxes 350 and 360 have a size and shape suitable for identifying a sub-area within the designated area of interest in which the feature resides or is located. For example, each bounding box 350 and 360 defines a specific area of interest or geographical area within the selected watchbox 202 from which features used to monitor the level or change in activity are obtained. According to an exemplary embodiment of the present disclosure, each bounding box 350 and 360 can be associated with metadata which specifies geospatial or (GPS) coordinates within the designated area of interest, an object from which the feature was obtained, a time stamp identifying when the feature was obtained, or any other information as desired. The attribute files 370 can be included in received data which includes text and/or sound. The attribute file 370 includes information identifying characteristics or properties of the received data, and can include metadata and any additional information defined through user- or machine-processing. For example, the attribute file 370 can include a data source identifier, a time-stamp (e.g., specific date or date range, specific time or time range, etc.), a data type, a user- or machine-defined classification, identification, or analysis result, or any other suitable data descriptive information as desired.

As shown in FIG. 3B, if the received data includes image data, the processing device 108 uses the one or more bounding boxes 350 included in the received data to execute a comparison based on image properties or characteristics, including for example, hue, a pre-identified feature or object, pixel values, or any other image property as desired. As shown in FIG. 3C, if the received data includes acoustic data, the processing device 108 is configured to use one or more bounding boxes 360 and/or attribute files 370 included in the received data to compare feature data from the received data to one or more feature indicators according to acoustic properties including, for example, one or more of predetermined frequency ranges, specified frequencies, specified tonal patterns, speech patterns, etc. According to an exemplary embodiment, the acoustic data can include ambient noise where intermittent events related to vehicles such as a car horn, engine starting, idling, or revving; electric or manual tools, heavy machinery, or other sound can be detected. According to another exemplary embodiment, the acoustic data can include speech where aural features (e.g., distress, anger, fear, etc.) of a voice can be identified. As shown in FIG. 3D, if the received data is a document or includes text or character-based information, the processing device 108 is configured to use an attribute file 370 attached to or included in the received data to execute a comparison of the feature data included in the one or more bounding boxes to one or more feature indicators of the selected watchboxes according to text properties including, for example, characters, whole or partial words, phrases, or text patterns. It should be readily apparent and understood by one of skill in the art that received data can include one of or any combination of bounding boxes 350, 360 and attribute files 370. Moreover, the comparison models, which use the bounding boxes and attribute files, can be configured to perform the feature comparison according to known processing techniques and algorithms according to the data type.

The processing device 108 can also be configured to analyze the one or more features of the received data against the one or more feature indicators 305 associated with the one or more selected watchboxes 200, 202 to determine whether at least one indicator threshold associated with the one or more feature indicators or combinations of the one or more feature indicators is met. For example, by using the one or more bounding boxes 350, 360 and/or attribute files 370 provided in the received data to compare features with the feature indicators 305 of the one or more selected watchboxes 202, the processing device 108 can be configured to determine an amount of change between a current analysis result and one or more previous analysis results stored in the memory device 104. For example, if the selected activity model 300 is configured for monitoring the increased use of an airstrip, the one or more bounding boxes 350, 360 and attribute files 370 provided with the received data can be used to detect the presence of aircraft at the airfield. The feature indicators 305 of one of the watchboxes 200,202 can be set to include baseline data values which include one or more reference values for monitoring the number of vehicles and/or aircraft against a specified indicator threshold (e.g., >10 vehicles and 30% more aircraft relative to the baseline value), and the feature indicators 305 of another watchbox 202 selected by the activity model can be set to monitor a number of aircraft and buildings against a specified threshold (e.g., >4 aircraft and >2 new buildings). If the threshold in either watchbox is met or exceeded, the processing device 108 can be configured to generate a data signal 330 as an alert signal, which indicates whether the one or more features trigger a reportable activity based on an indicator threshold associated with the one or more feature indicators 305 or one or more combinations of the one or more feature indicators 305. The data signal 330 can be encoded with information associated with at least one of: the at least one selected watchbox 202, the one or more features of the received data analyzed in the at least one selected watchbox 202, and an analysis result indicating whether the one or more features of the received data trigger a reportable activity. For example, the alert signal 330 can specify that increased use of the airstrip was detected, identify the image of the airstrip, and identify the changes in activity (e.g., more aircraft detected, more buildings detected, more vehicles detected).

The processing device 108 can be configured to store, in the memory device 106, one or more change indicators that measure an amount of change in the at least one selected watchbox based on the features of the received data and the one or more feature indicators 305 associated with the at least one selected watchbox 202. If a change indicator does not meet or exceed the associated feature indicator 305 threshold (or combination of feature indicator thresholds), the processing device 108 is configured to store the analysis result in the memory device 104, extrapolate data from the stored analysis result to identify one or more changes in features, which if included from future received data, would cause the change indicator to meet or exceed the associated indicator threshold(s), and store the extrapolated data in the memory device 106. According to an exemplary embodiment, the processing device 108 can be configured to include or access one or more Bayesian belief networks, machine learning algorithms, artificial intelligence algorithms, or any other intelligent algorithms as desired for executing and updating the feature indicators, feature indicator thresholds, and or change indicators of the comparison modules.

According to an exemplary embodiment, the contextualization of data could involve analysis that is not limited or bounded by geospatial considerations. For example, an organization, government, or entity may have a need or desire to monitor social media or multiple communication platforms for threats of violence or extreme acts. A user or operator could define a watchbox with specified feature indicators for monitoring the various communication platforms to determine whether a threat exists. The organization could define the watchbox with feature indicators as follows:
Relevant Time Range: Apr. 1-Jun. 1, 2020
Targeted Entity: United States
Sentiment Towards Entity: Negative

Any received data can be analyzed to determine whether it corresponds to any of the available watchboxes including the watchbox defined above. Assuming a correspondence with the above-defined watchbox exists, the processing device 108 can select the watchbox and compare the attribute file(s) of the received data to determine whether a reportable event and/or alert is triggered. For example, the received data would include an attribute file identifying at least a corresponding Targeted Entity, Sentiment, and time stamp which falls within the Relevant Time Range of the watchbox. These features and others can be assessed against threshold values for the alert determination. For example, the threshold values could relate to the type of weapons used, type of attack, intended location of attack, source of the threat, location of the threat, time frame of planned attack, etc.

According to exemplary embodiments of the present disclosure, the processing device 108 can include one or more hardware processors and be configured as a special purpose or a general purpose processing device which executes program code or software for performing the exemplary functions and/or features disclosed herein. The one or more hardware processors can comprise a microprocessor, central processing unit, microcomputer, programmable logic unit, or any other suitable processing devices as desired. The processing device 108 can be connected to a communications infrastructure 114 including a bus, message queue, network, or multi-core message-passing scheme, for communicating with other components of the computing device 100, such as the receiving device 102, the transmitting device 104, and an I/O interface 110.

According to yet another exemplary embodiment of the present disclosure, the processing device 108 can include or be configured to access one or more software modules and/or program code for performing and/or executing the exemplary embodiments disclosed herein.

The output device 110 can be configured to output the data signal. The output device 110 can be implemented as a display device, printer, speaker, or any suitable output device with a desired output format as desired. According to an exemplary embodiment, the output device 110 can include or connected to receive data from the processing device 108 via an input/output (I/O) interface 112. The I/O interface 112 can include a combination of hardware and software components and be configured to convert the output of the processing device 108 into a format suitable for output on one or more output/peripheral devices 130. For example, the I/O interface 112 can be configured to display one or more watchboxes 202, bounding boxes 350, 360 and/or attribute files 370 based on user input and data included in the received data and calls to one or more application program interfaces 325 which communicates with software executed by the processing device 108.

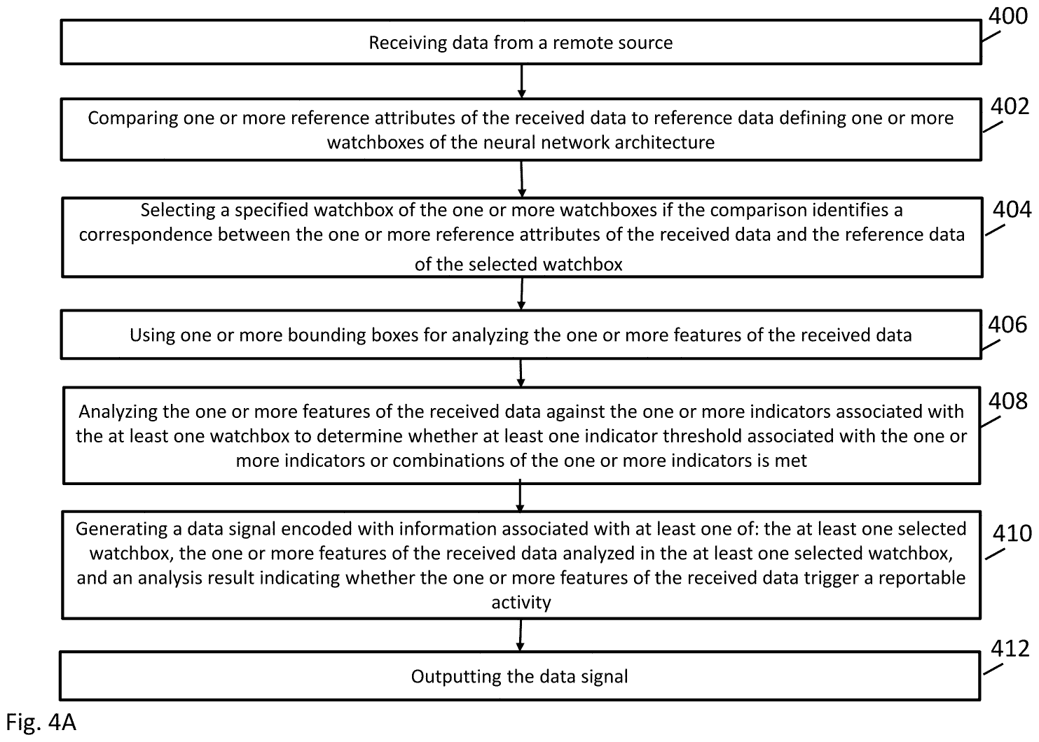

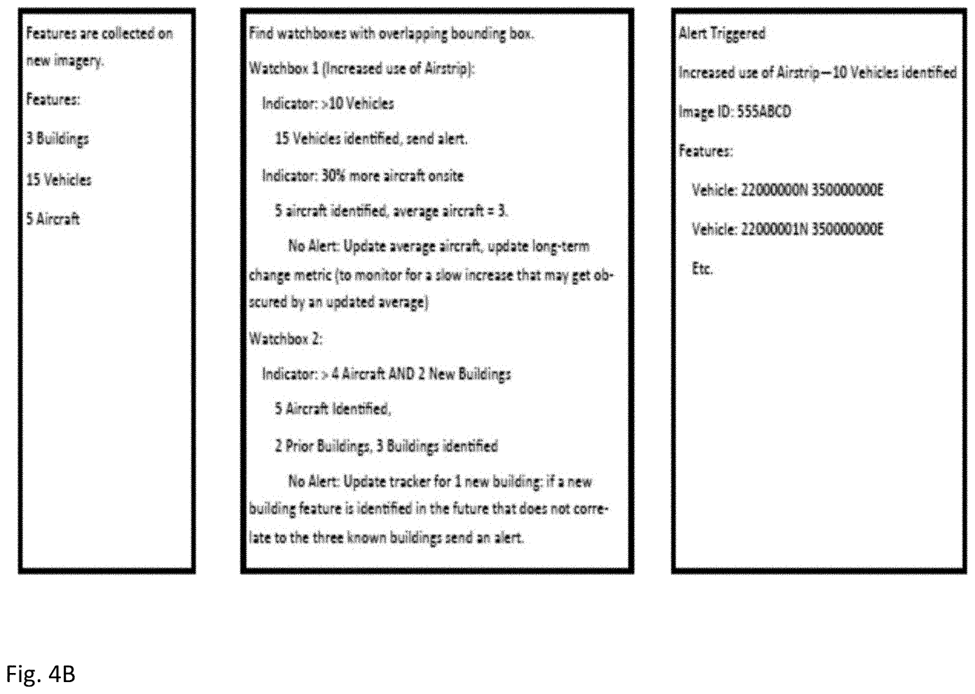

FIGS. 4A and 4B illustrate a method for monitoring an area of interest in accordance with an exemplary embodiment of the present disclosure.

As shown in FIG. 4A, the method includes receiving, in the receiving device 104 of the computer system 100, data from a remote source 120 (Step 400). The processing device 108, compares one or more reference attributes of the received data to reference data of an activity model 300 associated with one or more watchboxes 200 (Step 402). As shown in FIG. 4B, the activity model can be related to an airstrip and the collected features can include properties associated with an airstrip including buildings, vehicles, and aircraft. According to an exemplary embodiment, the collected features can include intelligence from postings or conversations on social media, email, Short Message Service (SMS), and/or blogs related to the airstrip. The collected features can also include voice communications via a cellular network, broadband, short-wave radio frequencies, or other communication technologies as desired. At Step 404, the processing device 108 selects a specified watchbox 200 of the one or more watchboxes 200 associated with the activity model 300 if the comparison identifies a correspondence between the one or more reference attributes of the received data and the reference data of the selected watchbox 200. The processing device 108 uses one or more bounding boxes 350, 360 and/or attribute files 370 provided with or in the received data for comparing one or more features of the received data with the one or more feature indicators 305 associated with the at least one selected watchbox 202 (Step 406). The bounding boxes 350, 360 and/or attribute files 370 identify the one or more features of the received data in the context of the area in which the features reside, and compare the features against the one or more feature indicators 305 associated with the at least one selected watchbox 202 to determine whether the one or more features trigger a reportable activity. The reportable activity being triggered based on an indicator threshold associated with the one or more feature indicators or one or more combinations of the one or more feature indicators (Step 408).

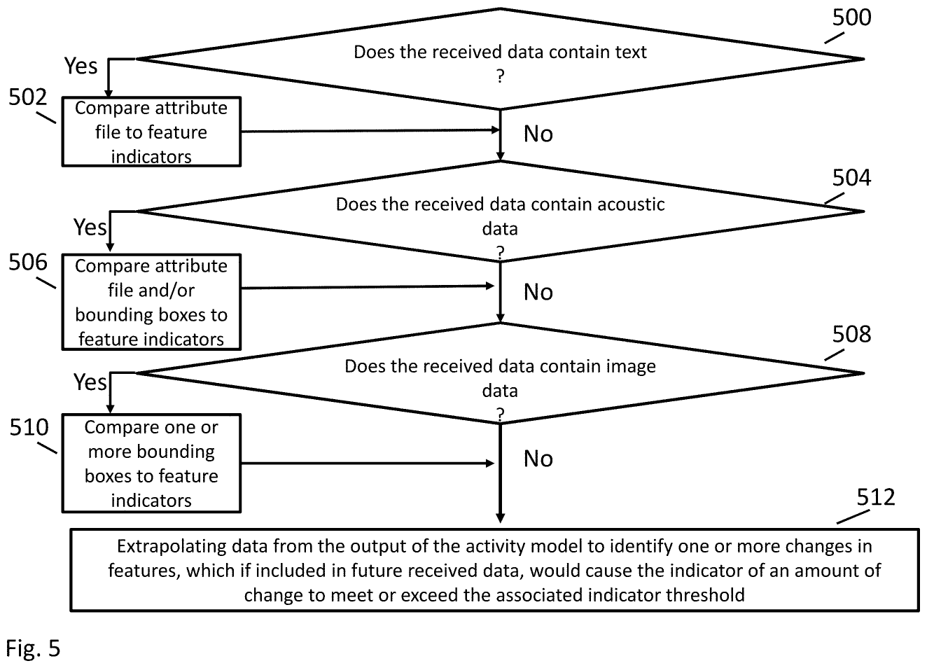

FIG. 5 illustrates an analysis process performed by the processing device in accordance with an exemplary embodiment of the present disclosure.

As already discussed, the one or more bounding boxes 350, 360 and/or attribute files 370 provided with or in the received data can be used to analyze the features of the received data against the feature indicators of a selected watchbox. For example, if the received data includes text data (Step 500), the processing device 108 compares the feature(s) contained in the attribute file against the feature indicators of the selected watchbox (Step 502). If the received data includes acoustic data (Step 504), the processing device 108 compares the feature(s) provided in the one or more bounding boxes and/or attribute files provided with the received data to the feature indicators of the selected watchbox (Step 506). If the received data includes image data (Step 508), the processing device 108 compares the feature(s) provided in the one or more bounding boxes provided in the received data against one or more feature indicators associated with the selected watchbox 202 (Step 510). In performing the analysis on the features of the received data, the processing device 108 can extrapolate data from the output of the activity model to identify one or more changes in features, which if extracted from future data, would cause the corresponding change indicator to meet or exceed the associated change indicator threshold (Step 512). It should be understood that while the exemplary embodiment of FIG. 5 relates to image, text, and acoustic data, the process and analysis can be modified for application to any type of data received from one or more remote data sources as desired.

Once the features in the received data have been analyzed, as shown in FIG. 4A, the processing device 108 generates a data signal encoded with information associated with at least one of: the at least one selected watchbox 202, the one or more features of the received data analyzed in the at least one selected watchbox 202, and an analysis result indicating whether the one or more features of the received data trigger a reportable activity (Step 410). FIG. 4B provides a graphic representation of the type of data included in the data signal. The data signal is sent to an output device 130 configured to output the data signal (Step 412).

The computer program code for performing the specialized functions described herein can be stored on a computer usable medium, which may refer to memories, such as the internal or external memory devices for the computing device 102 which can be memory semiconductors (e.g., DRAMs, etc.). The computer usable medium with stored program code constitutes a computer program product which can be a tangible non-transitory means for providing software to the computing device 102. The computer programs (e.g., computer control logic) or software can be stored in the memory device. The computer programs can also be received via the communications interface. Such computer programs, when executed, can enable the computing device 102 to implement the present methods and exemplary embodiments discussed herein. Accordingly, such computer programs may represent controllers of the computing device 102. Where the present disclosure is implemented using software, the software can be stored in a non-transitory computer readable medium and loaded into the computing device 102 using a removable storage drive, an interface, a hard disk drive, or communications interface, etc., where applicable.

The one or more processors of the computing device 102 can include one or more modules or engines configured to perform the functions of the exemplary embodiments described herein. Each of the modules or engines can be implemented using hardware and, in some instances, can also utilize software, such as program code and/or programs stored in memory. In such instances, program code may be compiled by the respective processors (e.g., by a compiling module or engine) prior to execution. For example, the program code can be source code written in a programming language that is translated into a lower level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that may be suitable for translation of program code into a lower level language suitable for controlling the computing device 102 to perform the functions disclosed herein. It will be apparent to persons having skill in the relevant art that such processes result in the computing device 102 being specially configured computing devices uniquely programmed to perform the functions discussed above.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein.

What is claimed is:

1. A computer system for monitoring an area of interest for activity, comprising:
a receiving device configured to receive data including one or more features of the area of interest;
a memory device configured to store (i) reference data comprised of a baseline of data values corresponding to feature indicators, where the feature indicators define one or more metrics for activities monitored via one or more watchboxes associated with the area of interest, and the baseline of data values corresponds to one or more reference values associated with the feature indicators, and (ii) activity data corresponding to one or more of the feature indicators of the one or more watchboxes;
a computing device configured to:
compare one or more features of the received data to the reference data of at least one of the feature indicators of the one or more watchboxes;
select at least one watchbox of the one or more watchboxes if the comparison identifies a correspondence between the one or more features of the received data and the reference data of the selected watchboxes;
analyze the one or more features of the received data against the one or more reference data of the feature indicators associated with the selected watchboxes to determine whether the one or more features trigger a reportable activity based on an indicator threshold associated with the one or more feature indicators or one or more combinations of the one or more feature indicators; and
generate a data signal encoded with information associated with at least one of: the selected watchboxes, the one or more features of the received data analyzed in the selected watchboxes, and an analysis result indicating whether the one or more features of the received data trigger a reportable activity; and
an output device configured to output the data signal.

2. The computer system of claim 1, wherein the output device includes one or more user interfaces configured to output at least a portion of the data signal associated with the selected watchboxes.

3. The computer system of claim 1, wherein the memory device is configured to define relationships between a plurality of feature indicators such that at least one of the one or more feature indicators is a combination of at least two other feature indicators.

4. The computer system of claim 1, wherein the receiving device is configured with an interface for receiving the data in at least one of a plurality of data types.

5. The computer system of claim 4, wherein the plurality of data types includes at least one or more of image data, acoustic data, or text data.

6. The computer system of claim 1, wherein the remote source includes one or more sensors, a processing device, or a database.

7. The computer system of claim 1, wherein the selected watchbox is configured to monitor an activity according to at least one of spatial, temporal, and spectral properties.

8. The computer system of claim 1, wherein the computing device is configured to apply each watchbox according to a respective activity model that corresponds to the specified activity to be monitored.

9. The computer system of claim 8, wherein the computing device is configured to use one or more bounding boxes and/or attribute files provided with the received data for comparing the one or more features of the received data against the one or more baseline data of the corresponding feature indicators of the one or more selected watchboxes.

10. The computer system of claim 9, wherein if the received data includes images, image features of the one or more bounding boxes are compared against one or more feature indicators associated with image properties.

11. The computer system of claim 9, wherein if the received data includes text, text features of the one or more attribute files are compared against one or more feature indicators associated with text properties.

12. The computer system of claim 9, wherein if the received data includes acoustic data, acoustic features of the one or more bounding boxes and/or attribute files are compared against one or more feature indicators associated with acoustic properties.

13. The computer system of claim 9, wherein the memory device is configured to store at least the comparison result.

14. The computer system of claim 13, wherein, via the activity model, the computing device is configured to determine an amount of change between a current comparison result and one or more previous comparison results stored in the memory device.

15. The computer system of claim 14, wherein the memory device is configured to store one or more amounts of change indicators that measure an amount of change in the at least one selected watchbox based on the features in the received data and the one or more feature indicators associated with the at least one selected watchbox.

16. The computer system of claim 15, wherein if the change indicators do not meet or exceed associated change indicator thresholds comprised of corresponding amounts of change of the feature data of the corresponding one or more feature indicators, the computing device is configured to store the comparison result in the memory device, extrapolate data from the stored comparison result to identify one or more changes in the features, which if such change in received feature data were included in future received data, would cause the change indicators to meet or exceed the associated change indicator thresholds, and store the extrapolated data in the memory device.

17. A method for monitoring an area of interest for activity via a computer system having a computing device configured to execute one or more software modules, the method comprising:
receiving, in a receiving device of the computer system, data including one or more features of an area of interest;
storing, in a memory device, (i) reference data comprised of a baseline of data values corresponding to feature indicators, where the feature indicators define one or more metrics for activities monitored via one or more watchboxes associated with the area of interest, and the baseline of data values corresponds to one or more reference values associated with the feature indicators, and (ii) activity data corresponding to one or more of the feature indicators of the one or more watchboxes;
selecting, via a processing device of the computing device, at least one watchbox of the one or more watchboxes if a comparison identifies a correspondence between the one or more features of the received data and the reference values of the at least one selected watchbox;
analyzing, in a processing device of the computer system, the one or more features of the received data against the one or more reference values of the feature indicators associated with the at least one selected watchbox to determine whether the one or more features of the received data trigger a reportable activity based on an indicator threshold associated with the one or more feature indicators or one or more combinations of the one or more feature indicators;
generating, in the processing device of the computing device, a data signal encoded with information associated with at least one of: the at least one selected watchbox, and an analysis result indicating whether the one or more features of the received data trigger a reportable activity; and
outputting the data signal via an output interface or transmitter of the computing device.

18. The method of claim 17, wherein analyzing features from the data comprises:
using, via the activity model executed by the computing device, one or more bounding boxes and/or attribute files provided in the received data for comparing the features of the received data to the indicator threshold associated with the one or more feature indicators or one or more combinations of the one or more feature indicators.

19. The method of claim 18, wherein if the features of the received data include images, the method comprises:
comparing image features in the one or more bounding boxes against feature indicator thresholds associated with image properties.

20. The method of claim 18, wherein if the features of the received data include text, the method comprises:
comparing text features in the one or more attribute files against feature indicator thresholds associated with text properties.

21. The method of claim 18, wherein if the features of the received data include acoustic data, the method comprises:
comparing acoustic features in the one or more bounding boxes and/or attribute files against feature indicator thresholds associated with acoustic properties.

22. The method of claim 17, comprising:
extrapolating data from the output of the activity model to identify one or more change thresholds comprised of amounts of change between received feature data and reference values for corresponding feature indicators, where if amounts of change with respect to future received data exceed such change thresholds an alert would be triggered.

23. The method of claim 22, comprising:
storing, in a memory device of the computer system, the analysis result and the change thresholds.

24. The method of claim 17, wherein the selected watchbox is configured to monitor an activity according to at least one of spatial, temporal, and spectral properties.

25. The method of claim 17, wherein the at least one watchbox is selected based on a prior analysis of the extracted features in a previously selected watchbox.
